(19) United States
(12) Patent Application Publication
(10) Pub. No.: US 2016/0318242 A1
(43) Pub. Date: Nov. 3, 2016

(54) METHOD FOR FASTENING AN ELEMENT TO A PIN

(71) Applicant: PLASTIC OMNIUM ADVANCED INNOVATION AND RESEARCH, Bruxelle (BE)

(72) Inventor: Nicolas RIVENET, Venette (FR)

(73) Assignee: PLASTIC OMNIUM ADVANCED INNOVATION AND RESEARCH, Brussels (BG)

(21) Appl. No.: 15/109,016

(22) PCT Filed: Dec. 23, 2014
(86) PCT No.: PCT/FR14/53531

§ 371 Date: Jun. 29, 2016

(30) Foreign Application Priority Data
Dec. 31, 2013 (FR) 1363748

(51) Int. Cl. B29C 65/60; B29C 65/82; B29C 65/00; B29C 65/18

(52) U.S. Cl. CPC B29C 65/606; B29C 65/18; B29C 65/82; B29C 66/532; B29C 66/91411; B29C 66/9241; B29L 2031/7172

(57) ABSTRACT

A method for fastening an element to a wall of a tank, the wall including at least one pin made from plastic material. The method includes: (a1) mounting the element on the pin such that a traversing part of the pin passes through the element, (a2) melting at least a portion of the traversing part and pressing on the melted portion such that the melted portion wraps freely around the pin to form a pin head configured to hold the element on the pin.

The present invention relates to a method for attaching an element to a wall of a tank, this wall having at least one plastic pin.

A liquid tank in a vehicle comprises a wall which delimits a space containing this liquid (it may for example be a tank intended to contain a solution of urea which will be used to clean the exhaust gases using selective catalytic reduction). In some instances, there is a desire to attach a rigid plate to an internal face of this wall while maintaining a predetermined distance between this plate and this internal face. Thus, this plate is situated inside the tank and is entirely immersed in the liquid. For example, this plate is a heater plate, which is then able to heat the liquid.

In order to attach such a plate use is made of a number of plastic pins extending from the internal face of the wall toward the inside of the wall, substantially at right angles thereto. The distal part of the pin refers to the part thereof that is furthest away from this internal face and which is situated on the other side of the plate once this plate has been mounted on the pin (one way of mounting the plate on the pin is to pass the distal part of the pin through a hole in the plate). The proximal part of the pin refers to the other part of the pin, situated between the wall and the plate. The pin is configured in such a way that it holds the plate a fixed distance away from the wall, for example the proximal part of the pin is unable to pass through the hole in the plate whereas the distal part may pass through this hole.

In order to attach the plate to the pin, and therefore secure it to the wall, a heading die, heated above ambient temperature, is applied with a certain pressure to the distal part of the pin. A heading die refers to a tool that has a face intended to be heated and pressed against the component that is to be deformed.

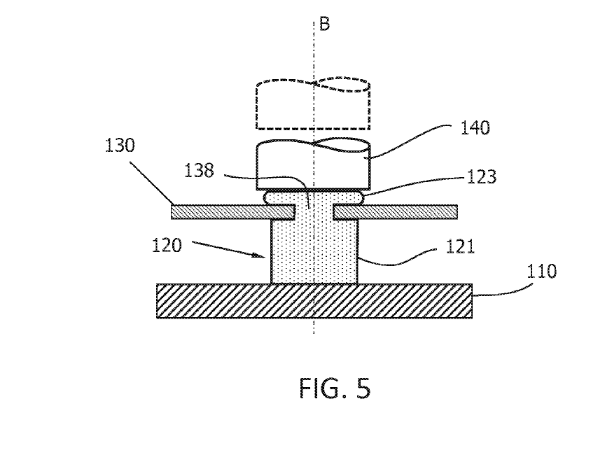

FIG. 5 illustrates this method according to the prior art for attaching a rigid plate 130 to a wall 110 using a pin 120. FIG. 5 is a view in cross section of such a plate 130 attached to the pin 120 at the end of this method according to the prior art. What is meant by a rigid plate is a plate that during the process of crushing the pin 120 does not deform appreciably, i.e. to an extent visible to the naked eye.

The pin 120 extends in a longitudinal direction B. The distal part 123 of the pin 120 is inserted into a hole 138 in the plate 130 so that the distal part 123 has passed through the hole 138 and extends beyond the hole 138. The proximal part 121 of the pin is thus situated between the plate 130 and the wall 110. The proximal part 121 is unable to pass through the hole 138 because its cross section is greater than the cross section of the hole 138. The plate 130 is thus held at the interface between the proximal part 121 and the distal part 123 of the pin.

The heated face of a heading die 140 is pressed against the distal part 123 by moving this heading die 140 along the longitudinal axis B toward the wall 110. Under the effect of the heat and pressure, the distal part 123 deforms, being sandwiched and crushed between the plate 130 and the heading die 140, and spreads over the plate 130 around the hole 138. The distal part 123 is thus clamped between the plate 130 and the heading die 140.

Because the proximal part 121 has undergone very little heating in comparison with the distal part 123 and has been in part protected from the action of the heading die 140 by the plate 130, the proximal part 121 undergoes no significant deformation. The heading die 140 is then moved away in order to limit the spread of the distal part 123 and to allow this distal part 123 to cool. The dotted line depicts the heading die 140 in this moved-away position.

After it has cooled, the pin 120 has the shape of a mushroom, the head of which is the deformed distal part 123 and the stalk of which is the proximal part 121. The wall 130 is thus held at the interface between the proximal part 121 and the distal part 123. Specifically, because the distal part 123 spreads laterally beyond the hole 138 in the plate 130, this distal part can no longer slide back out of the hole 138.

If need be, the above process is repeated for each of the pins on which the plate is mounted. In that case, the pins are crushed in succession. Alternatively, all of the pins are simultaneously deformed and crushed against the plate by heated heading dies.

In some cases, the element that is to be attached to the pins is not a rigid plate but a more flexible element. For example, this element is a membrane, for example made of a fabric with fibers. When the above method is used to crush the distal part of the pin, the flexibility of the element prevents the distal part from being flattened by being crushed between this element and the heading die. As a result, the distal part, and also the proximal part, deform undesirably. For example, the proximal part is crushed and shortened, or the proximal part is bent over sideways. Thus, such an element cannot be held correctly on a pin at a predetermined distance away from the wall that represents the height of the proximal part.

It is also possible for the pin and/or the element to be configured in such a way that during movement of the heading die, the distal part is not crushed between this element and the heading die, even if the element is a rigid plate. Such would be the case for example if the height-to-diameter ratio of the pin was high enough for the proximal part to buckle or if the pin were not aligned with the direction of the compression force applied by the heading die. In that case, the pin would become damaged and the element would not be able to be held correctly on the pin.

The present invention seeks to overcome these disadvantages.

The invention seeks to propose a method that allows an element to be attached in a stable manner to a pin and, by extension, to a plurality of pins.

This object is achieved by virtue of the fact that the method comprises the following steps:
(a1) the element is mounted on the pin such that a penetrating part of the pin passes through this element,
(a2) a portion of this penetrating part is melted and pressure is applied to the molten portion such that the molten portion rolls freely around the pin so as to form a pin head configured to hold the element on the pin.

By virtue of these measures, the combination of the heating of a portion of the distal part and of the pressure applied to this molten portion allows this portion to be deformed by free rolling into a head, without load from the element. There is therefore practically no load applied to the proximal part of the pin situated between the element and the wall (the part that has not passed through the element), and no undesirable deformation of the pin and, in particular, of the proximal part thereof. Undesirable is qualified as pin deformation that renders it unable to attach the element in a stable manner. Thus, according to the invention, the element is attached in a stable manner to the pin.

For example, according to the invention, the wall has a plurality of pins, and immediately after step (a1), a step (b1) of evening the surface is performed on a first group of the pins, and then in a step (b2), the step (a2) is performed on each of the pins of the first group, this surface-evening step consisting in applying a determined pressure to compensate for the fact that not all of the ends of the penetrating parts of the pins of the first group are coplanar.

For example, according to the invention, after step (b2), a step (b3) of evening the surface is performed on a second group of the pins distinct from the first group, and then in a step (b4) the step (a2) is performed on each of the pins of the second group, this surface-evening step consisting in applying a determined pressure to compensate for the fact that not all of the ends of the penetrating parts of the pins of the second group are coplanar.

For example, according to the invention, after step (b4), a step (b5) is performed in which steps (b3) and (b4) are repeated with another group of the pins.

For example, according to the invention, after step (b5), a step (b6) is performed in which step (b5) is repeated until the element is attached to all the pins.

Thus, in the instances in which not all of the ends of the penetrating parts of the pins of the wall of the tank come simultaneously into contact with the tool performing the evening step, the pins that are first to come into contact with this tool (the first group) are deformed without being damaged by this tool, then the remaining pins are deformed in successive groups.

Damage is to be understood to mean deformation of the pin that renders it unable to attach the element in a stable manner to this pin (for example because the proximal part (defined hereinabove) of the pin has become twisted, inclined, or deformed in some other undesirable way.

At the end of the repetitions, the element is therefore attached in a stable manner to each of the pins.

The invention also relates to a tank with a wall having at least one plastic pin of which a penetrating part passes through an element.

According to the invention, a portion of this penetrating part is deformed by rolling freely around the pin to form a pin head configured to hold the element on the pin.

The invention will be clearly understood and the advantages thereof will become more apparent from reading the detailed description which follows, of one embodiment given by way of nonlimiting example. The description makes reference to the attached drawings in which:

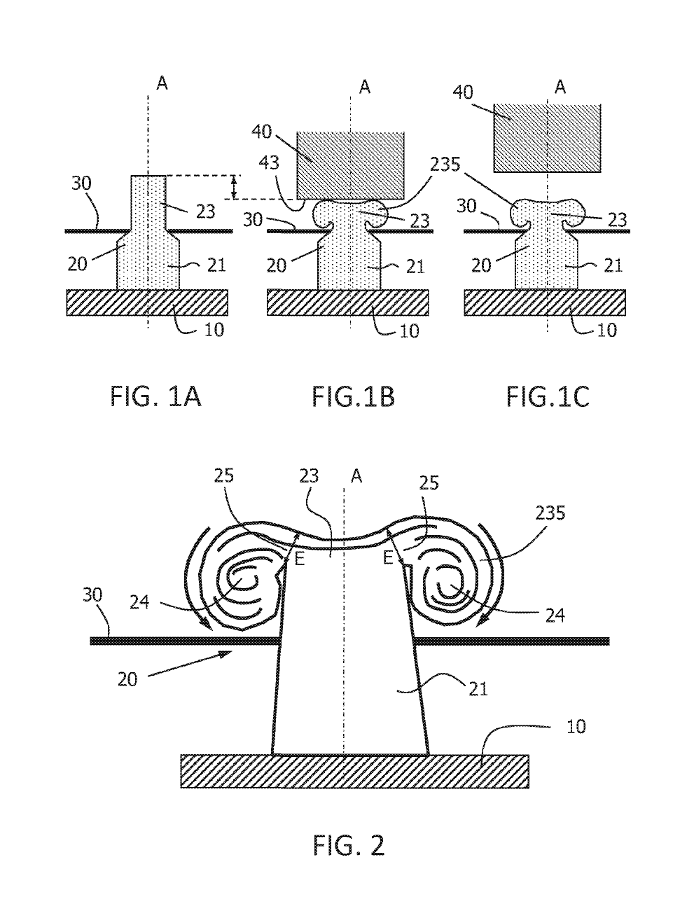

FIGS. 1A, 1B, and 1C illustrate various successive steps in the method of attaching an element to a pin according to the invention,

FIG. 2 is a view in longitudinal section of a pin that is deformed following application of the method according to the invention,

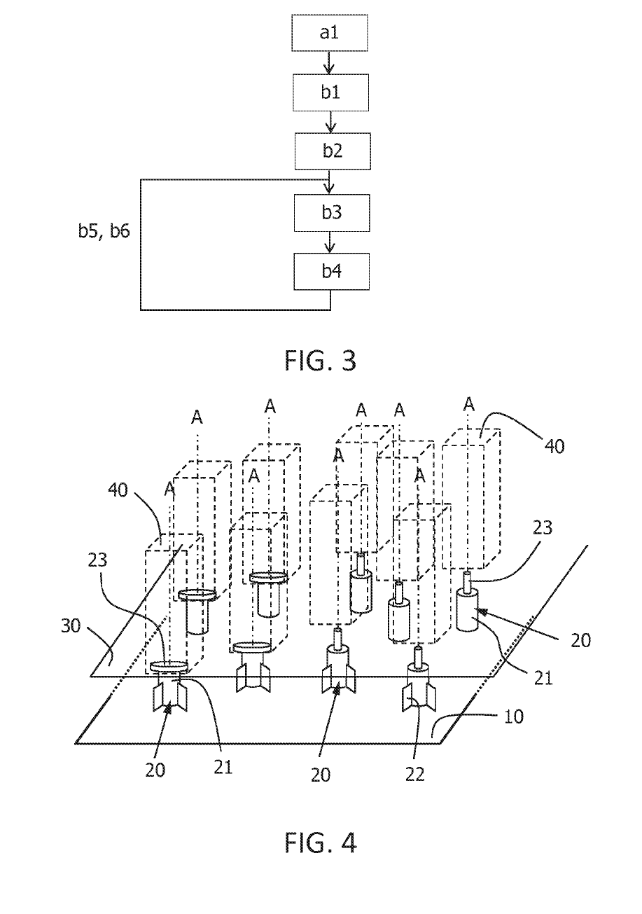

FIG. 3 depicts the various steps in attaching an element to several pins of a wall according to the method of the invention,

FIG. 4 is a perspective view of an element attached to several pins of a wall according to the method of the invention,

FIG. 5, already described, depicts a pin deformed by a method according to the prior art.

Consider a wall 10 of a tank. One or more pins 20 made of plastic extend along a longitudinal axis A which is substantially at right angles to the surface of the wall 10 at the interface between the pin 20 and the wall 10. FIG. 1A is a view in longitudinal section of such a pin 20.

For example, this or these pins 20 are situated on an interior wall 10 of the tank.

The method of attaching an element 30 to a pin 20 is described hereinbelow. This method may of course be repeated in exactly the same way for each of the pins 20 of the wall 10.

An element 30 is mounted on the pin 20 by slipping the pin 20 through an orifice that already exists in the element 30 and which passes through this element 30. If the element 30 is a woven component, for example a fabric made of fibers, this orifice is one of the meshes of this element. If the element 30 is a nonwoven, for example a sheet of plastic or of metal, this orifice is a hole pierced in or molded into this element 30.

Alternatively, the element 30 is mounted on the pin 20 by having the pin 20 pierce this element 30.

The pin 20 has a penetrating part 23 which is the part of the pin 20 furthest away from the wall 10 (the distal part of the pin 20), and which has passed through the element 30 during the mounting of the element 30 on the pin 20 (step (a1) of the method according to the invention). The proximal part 21 of the pin 20 denotes the other part of the pin 20, which is situated between the wall 10 and the element 30. The pin 20 is configured such that it holds the element 30 a fixed distance away from the wall 10, mainly the height (measured along the longitudinal axis A) of the proximal part 21. For example, the proximal part 21 of the pin 20 is unable to pass through an orifice in the element 30 whereas the distal part 23 can pass through this orifice in the element 30.

For example, the pin widens from its distal part 23 toward its proximal part 21 in the form of a conical portion situated at the interface between these two parts.

The heading die 40 has a face (contact face 43) which is intended to be heated and pressed against the distal part 23 so as to deform same.

This contact face 43 may be planar or convex.

The invention is described hereinbelow in the case of the element 30 being more flexible than the pin 20.

For example, the element 30 is a membrane, namely an element of which one of the spatial dimensions (the thickness) is very much smaller in comparison with the other two, and of which the compression stiffness is very much lower than the tension stiffness.

For example, this element 30 is a heating membrane, and the wall 10 forms part of a tank intended to contain a liquid, for example urea.

However, the invention also applies to cases in which the element 30 is not a membrane, for example being a rigid plate the rigidity of which is at least equal to that of the pin 20.

According to the invention, a portion 235 of the penetrating part 23 is melted and pressure is applied to the molten portion 235 such that the molten portion 235 rolls freely around the pin 20 so as to form a pin head configured to hold the element 30 on the pin 20 (step (a2)).

The portion 235 may represent just part, or all, of the penetrating part 23.

What is meant by “melt” is that the material of the portion 235 is heated to a heated temperature T at which it is in a pasty state somewhere between a solid state and liquid state.

Advantageously, this heating of the portion 235 is carried out by heating the contact face 43 of the heading die 40 to the heated temperature T and bringing it into contact with the end of the penetrating part 23. The heading die 40 is then pressed against the end of the penetrating part 23 of the pin 20 such that the contact face 43 applies, along the longitudinal axis A, a pressure P to this penetrating part 23. This step is illustrated in FIG. 1B.

The heated temperature T is close to the melting point T_{F} of the material of which the pin 20 is made. “Close to” means that the heated temperature T is within an interval of 50° C. around the melting point T_{F}.

Thus, the material deforms more readily and rapidly under the effect of the pressure applied by the heading die 40 to the pin 20.

For example, the heated temperature T is above the melting point T_{F}.

For example, the portion 235 is melted at constant temperature T_{c}, this being the heated temperature.

Constant temperature means a temperature which varies little about the value T_{c}, the temperature in practice being regulated by a regulating device. Thus, the portion 235 is melted at a substantially constant temperature which fluctuates around the mean temperature T_{c}.

For example, in the case of high density polyethylene, the temperature T_{c} is of the order of 200° C., and the variations about this temperature are of the order of ±15° C.

Thus, the portion 235 is raised rapidly to the temperature at which it takes on a pasty state and deforms before the rest of the penetrating part 23 (situated closer to the proximal part 21) heats up. Thus, the deformation of the proximal part 21 is further minimized.

Alternatively, the temperature T varies during the period of contact between the pin 20 and the heading die 40.

For example, the temperature T increases with duration of contact between the pin 20 and the heading die 40.

The pressure P of contact between the heading die 40 and the pin 20 varies over the period of contact between the heading die 40 and the pin 20 up to a maximum value P₀.

Advantageously, pressure is applied gradually to the molten portion 235 at a determined pressure P or determined rate V.

For example, the combination of the heated temperature T of the heading die 40 and of the pressure P applied by the heading die 40 to the portion 235 (or, which is equivalent, the combination of the heated temperature T and the rate of advance V of the heading die 40 along the longitudinal axis A against this portion 235) leads to deformation of the portion 235 such that the proximal part 21 undergoes no significant deformation, and is essentially only compressed along the longitudinal axis A. Initially (namely upon initial contact of the heading die 40 with the penetrating part 23), the temperature T of the heading die 40 is high enough (and/or the pressure P applied by the heading die 40 or the rate of advance V of the heading die 40 is low enough) that the portion 235 is given time to deform laterally (radially outward) whereas the proximal part 21 does not deform undesirably.

In particular, the pressure P applied by the heading die 40 to the portion 235 or the rate of advance V of the heading die 40 is chosen according to the temperature T_{c} such that the proximal part 21 of the pin 20 undergoes little or no deformation.

Thus, the proximal part 21 does not buckle (buckling refers, in a known way, to the phenomenon of instability of a structure subjected to a normal compressive force which deforms overall at right angles to the direction of compression) or does not bend over sideways appreciably under the action of the heading die 40.

Thus, according to the method of the invention, the membrane 30 remains positioned a predetermined distance away from the wall 10, at the interface between the penetrating part 23 and the proximal part 21 of the pin 20, the membrane 30 being held at this distance by the deformed penetrating part 23.

Advantageously, the surface area of the maximum cross section of the penetrating part 23 is strictly smaller than the minimum surface area of the cross section of the proximal part 21 of the pin 20.

This geometry of the pin 20 contributes to keeping the membrane 30 in its initial position (prior to step (a2)).

For example, the pin 20 is cylindrical and has a shoulder at the interface between its penetrating part 23 and its proximal part 21, the diameter of the cross section of the penetrating part 23 being smaller than the diameter of the cross section of the proximal part 21.

For example, the pin 20 is conical and widens from its penetrating part 23 toward its proximal part 21.

For example, the pin 20 on its proximal part 21 has fins 22 which extend longitudinally from the wall and radially outward. These fins 22 contribute to keeping the pin 20 aligned with the longitudinal direction along the axis A. These fins can be seen on some of the pins in FIG. 4.

Advantageously, after the step (a2), the heading die 40 is moved away so that it is no longer in contact with the pin 20. This situation is illustrated in FIG. 1C.

Thus, the molten portion 235 is allowed to cool and set more rapidly in the shape it has adopted after being compressed by the heading die 40.

Tests conducted by the inventors show that the molten portion 235 rolls freely around the pin 20 so as to form a pin head.

What is meant by a portion of a component rolling around the rest of this component is that this portion deforms progressively to form a spiral on itself.

According to the invention, the molten portion 235 of the pin 20 rolls freely, which means that no component other than the pin 20 interferes with this rolling. In particular, the element 30, whether it be flexible or rigid, does not interfere with this rolling.

FIG. 2 is a view in longitudinal section (in a plane containing the longitudinal axis A) of a pin 20 after it has been deformed by a heading die 40 according to the method of the invention. In this example, the pin 20 is of conical shape.

Under the action of the heading die 40, the molten portion 235 deforms by lateral expansion, then its annular lateral circumference rolls progressively on itself. This spiral rolling occurs initially in the direction of the proximal part 21, in the direction of the arrows in FIG. 2.

For example, the pin head formed by the deformation of the molten portion 235 has the shape of a torus 24 at the end of the rolling process and extends radially outward from the rest of the penetrating part (23). This torus 24 being centered on the longitudinal axis A and has the shape of an annular sausage.

In some instances, the central portion of the penetrating part 23 becomes hollow to form a depression centered on the longitudinal axis A.

The membrane 30 is thus held on the pin 20 by the torus 24 because this torus 24 extends laterally (radially) beyond the orifice in the membrane 30 through which the penetrating part 23 passed before being deformed by the method according to the invention.

The torus 24 is attached to the circumference of the distal end of the rest of the penetrating part 23 by an annular joining zone 25 visible in FIG. 2.

Tests conducted by the inventors show that the minimum thickness E of the joining zone 25 needs to be above a threshold value E_{S} in order to withstand a pull-out force F_{A}. The threshold thickness E_{S} is dependent on the material of the pin 20. For a pull-out force F_{A} equal to 140 N and a pin 20 made of high density polyethylene (reference HDPE CC252), the threshold thickness E_{S} is equal to 200 μm (microns).

Given the diversity of mechanical properties of the materials from which the pin is likely to be made, the combination of contact pressure P applied by the heading die 40 to the pin 20 and heated temperature T of the heading die 40 which is such that the pin 20 deforms by free rolling into a torus centered on the longitudinal axis A may vary. The values for the contact pressure P and for the heated temperature T cannot therefore be one set of values fixed for the entire range of materials from which the pin is likely to be made.

The proximal part 21 of the pin 20 is of non-zero length, as depicted in the figures.

In some instances, the proximal part 21 is of zero length. The membrane 30 is then attached against the wall 10 once the attachment method of the invention has been completed.

The invention also relates to a method for attaching an element 30 to a plurality of pins 20 extending from a wall 10.

The invention is described hereinbelow in the case where these pins 20 all extend substantially in a longitudinal direction A. The invention also applies to instances in which some of the pins 20 do not extend in the same longitudinal direction A.

The step (a1) described hereinabove is first of all performed for each of the pins 20 so that the penetrating part 23 of each pin 20 passes through the element 30 whereas the proximal part 21 of each pin 20 is situated between the element 30 and the wall 10.

Immediately after the step (a1), a step (b1) of evening the surface is performed on a first group of these pins 20.

The step (b1) consists in applying a determined pressure to only the first group of pins 20 in order to compensate for the fact that not all of the ends of the penetrating parts 23 of the pins 20 of the first group are necessarily coplanar, namely do not all lie in the one same plane. This is generally the case either because the pins 20 are not the same height (do not have the same length along the longitudinal axis A) or because the surface of the wall 10 bearing the pins 20 is not planar.

This step makes it possible to prevent certain pins 20 from experiencing excessive pressure under the action of the heading die 40 and becoming deformed undesirably.

In this step (b1), several heading dies 40 each intended to compress one of the pins 20 are brought up simultaneously, which means to say that the heading dies 40 all move together in the same translational movement along the longitudinal axis A until a first group of pins 20 comes almost simultaneously into contact with the heading dies 40. The contact surfaces 43 of the heading dies 40 are all situated in the same plane. Advantageously, the heading dies 40 are all mounted on one and the same support which undergoes a translational movement. Alternatively, a single heading die 40 with a large contact surface 43 able to touch each of the pins is moved in a translational movement.

The first group of pins 20 thus grips together the pins 20 of which, when the heading die or dies 40 (or more generally a tool) is lowered, the penetrating part 23 is in contact with the heading die or dies 40 without being compressed undesirably in the longitudinal direction, advantageously without being permanently compressed.

The movement consisting in “lowering” the heading die or dies 40 refers to the moving of these heading dies 40 closer to the wall 10 bearing the pins 20.

At this stage, the pins 20 not in this first group are not in contact with the heading die 40.

At this stage, the heading die 40 is not necessarily heated.

Advantageously, the heading die 40 is heated before step (b1) to a heated temperature, and remains heated to this heated temperature throughout all of the steps of the method according to the invention. This then avoids cooling and heating phases between these steps, and time is saved in processing the pins 20.

Next, in a step (b2), the step (a2) described hereinabove is performed on each of the pins 20 of the first group.

The element 30 is thus attached to all the pins 20 of the first group, these pins 20 having been deformed during the step (b2).

If the first group of pins 20 comprises all the pins 20, the element 30 is attached to all of the pins 20 at the end of step (b2) and the method according to the invention is stopped.

If, on the other hand, the element 30 is not attached to all of the pins 20 at the end of step (b2), a step (b3) of evening the surface is performed on a second group of pins (20) distinct from the first group. The step (b3) consists in applying a determined pressure to the second group of pins 20 to compensate for the fact that not all of the ends of the penetrating parts 23 of the pins 20 of the first group are necessarily coplanar.

Then, in a step (b4), the step (a2) is performed on each of the pins (20) of the second group.

The element 30 is thus attached to all the pins 20 of the second group, these pins 20 having been deformed during step (b4).

At the end of step (b2), the tool 40 may find itself brought into contact with the second group of pins merely because of the pressure applied to the molten portion 23 of the pins 20 of the first group of pins during step (b2). In that particular case, step (b3) is thus performed while step (b2) is being performed, and step (b4) is performed directly.

If necessary, namely if there are pins 20 not included in the first and second group, to which the element 30 is therefore not attached, a step (b5) is performed in which steps (b3) and (b4) are repeated with another group of pins (20).

If necessary, namely if there are pins 20 not included in the first and second groups and in this other group, to which the element 30 is therefore not attached, a step (b6) is performed in which step (b5) is repeated until the element 30 is attached to all the pins 20.

The various steps of the method are depicted in FIG. 3.

By virtue of the incremental approach according to the invention, in which each increment involves an evening-out step followed by a step during which a portion 235 of the penetrating part 23 of the pins 20 is melted, the pins 20 which first come into contact with the heading die 40 are prevented from experiencing too high a pressure too rapidly with a portion 235 of their penetrating part 23 not having time to melt and deform by free rolling, and these pins 20 are thus prevented from being deformed undesirably.

FIG. 4 illustrates a wall 10 which on its internal surface has several pins 20 extending substantially along a longitudinal axis A. This figure depicts the condition of the pins 20 between the step (b2) and the step (b3). Thus, the membrane 30 is attached to a first group of pins 20, and is not attached to a second group of pins 20.

For the sake of the clarity of the figure, the heading dies 40 have been depicted in dotted line. The first group of pins 20 is situated to the left, the second group of pins 20 is situated to the right in FIG. 4.

The invention also relates to a tank with a wall 10 having at least one plastic pin 20 a penetrating part 23 of which passes through an element 30, a portion 235 of this penetrating part 23 is deformed by free rolling around this pin 20 to form a pin head configured to hold the element 30 on the pin 20.

1-15. (canceled)

16: A method for attaching an element to a wall of a tank, the wall including at least one plastic pin, the method comprising:
(a1) mounting the element on the at least one pin such that a penetrating part of the pin passes through the element;
(a2) melting a portion of the penetrating part and applying pressure to the molten portion such that the molten portion rolls freely around the at least one pin to form a pin head configured to hold the element on the pin.

17: The method as claimed in claim 16, wherein the portion is melted at constant temperature.

18: The method as claimed in claim 17, wherein pressure is applied progressively to the molten portion with a determined pressure or at a determined rate.

19: The method as claimed in claim 18, wherein the pressure or the rate is chosen according to the constant temperature so that a proximal part of the pin, which is a part of the pin that has not passed through the element, undergoes little or no deformation.

20: The method as claimed in claim 16, wherein the pin head is in a shape of a torus at an end of the rolling process and extends radially outward from a rest of the penetrating part of the element.

21: The method as claimed in claim 16, wherein the at least one pin is situated on an interior wall of the tank.

22: The method as claimed in claim 16, wherein the element is more flexible than the at least one pin.

23: The method as claimed in claim 22, wherein the element is a membrane.

24: The method as claimed in claim 16, wherein the wall includes a plurality of the pins, and immediately after the mounting (a1), further comprising performing (b1) evening the surface on a first group of the pins, and then (b2) performing the melting (a2) on each of the pins of the first group, the surface-evening (b1) applying a determined pressure to compensate for the fact that not all of ends of the penetrating parts of the pins of the first group are coplanar.

25: The method as claimed in claim 24, wherein, in the evening (b1), a tool is lowered onto the first group of the pins such that each of the parts of the pins of the first group are in contact with the tool without being compressed undesirably in their longitudinal direction.

26: The method as claimed in claim 24, wherein, after the (b2) performing the melting (a2), further comprising performing (b3) evening the surface on a second group of the pins distinct from the first group, and then (b4) performing the melting (a2) on each of the pins of the second group, the surface-evening (b3) applying a determined pressure to compensate for the fact that not all of the ends of the penetrating parts of the pins of the second group are coplanar.

27: The method as claimed in claim 26, wherein, in (b3), the tool is lowered onto the second group such that each of the parts of the pins of the second group is in contact with the tool without being undesirably compressed in its longitudinal direction.

28: The method as claimed in claim 26, wherein, after (b4), further comprising performing (b5) repeating (b3) and (b4) with another group of the pins.

29: The method as claimed in claim 28, wherein, after (b5), further comprising performing (b6) repeating (b5) until the element is attached to all the pins.

30: A tank comprising a wall including at least one plastic pin of which a penetrating part passes through an element, wherein for the at least one pin a portion of the penetrating part is deformed by rolling freely around the at least one pin to form a pin head configured to hold the element on the pin.
